(19) United States
(12) Patent Application Publication
(10) Pub. No.: US 2025/0303449 A1
(43) Pub. Date: Oct. 2, 2025

(54) SYSTEMS AND METHODS FOR PARTICLE CLASSIFICATION

(71) Applicant: Group14 Technologies, Inc., Woodinville, WA (US)

(72) Inventors: Adam Vidoni, Woodinville, WA (US); Sydney Alexander, Woodinville, WA (US); Henry R. Costantino, Woodinville, WA (US); Christopher Timmons, Monroe, WA (US)

(21) Appl. No.: 19/081,962

(22) Filed: Mar. 17, 2025

Related U.S. Application Data
(60) Provisional application No. 63/571,930, filed on Mar. 29, 2024.

(51) Int. Cl. B07B 9/02; B07B 4/02

(52) U.S. Cl. CPC B07B 9/02; B07B 4/02

(57) ABSTRACT

Systems and methods for classifying carbon particles by size. Multiple classifiers separate carbon particles into size ranges. One or more of the size ranges of the carbon particles is separately infiltrated with an electrochemical modifier to create a uniform composite material. One or more of the uniform composite materials are blended according to a desired specification.

### CROSS-REFERENCE TO RELATED APPLICATION

This application claims the benefit of priority to U.S. Provisional Application No. 63/571,930, filed Mar. 29, 2024, the entire contents of which is incorporated herein by reference.

### BACKGROUND

Currently cyclone separators are used to separate out product from a mill, such as a jet mill. However, particle size accuracy provided by these devices results in non-uniform output during follow on procedures. Cyclone separators include handles that provide rough control over the cyclone separation, but greater control would allow for less loss and greater accuracy in producing high tolerance particle size distribution targets.

### BRIEF SUMMARY

Disclosed herein are manufacturing methods and systems for more accurately separating porous carbon particles based on particle size in order to improve uniformity electrochemical modifiers deposited within pores of the porous carbon particles.

In an illustrative embodiment, a method includes classifying pyrolyzed, activated carbon scaffold particles using a multi-stage classification system to produce multiple size classes of pyrolyzed, activated carbon particles and separately infiltrating pores of each size class of the pyrolyzed, activated carbon particles with an electrochemical modifier to form a plurality of uniformly sized composite particles.

In another illustrative embodiment, a system includes a porous carbon production system configured to produce pyrolyzed, activated carbon particles, a multi-stage classification system configured to separate the pyrolyzed, activated carbon particles into multiple size classes, and a chemical vapor infiltration system configured separately infiltrate pores of at least one of the size classes of the pyrolyzed, activated carbon particles with an electrochemical modifier to form uniformly sized composite particles. In still further embodiments parameters of the infiltrating are tuned to provide optimal results based on each class of pyrolyzed, activated carbon particles.

In still another illustrative embodiment, a particle classification system includes a plurality of elbow jet classifiers configured to separate pyrolyzed, activated carbon particles into multiple size classes.

### BRIEF DESCRIPTION OF THE DRAWINGS

FIG. 1 is a schematic of composite production system formed in accordance with an embodiment of the present invention.

FIG. 2 is a schematic of a particle size classification system, chemical vapor infiltration components, and blending components formed in accordance with an embodiment of the present invention.

FIG. 3 is a schematic of an exemplary particle separation column formed in accordance with an embodiment of the present invention.

FIG. 4 is a schematic of an exemplary three stage classifier formed in accordance with an embodiment of the present invention.

FIG. 5 is a schematic of an elbow jet classifier formed in accordance with an embodiment of the present invention.

### DETAILED DESCRIPTION

In the following description, certain specific details are set forth in order to provide a thorough understanding of various embodiments. However, one skilled in the art will understand that the disclosure may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed disclosure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

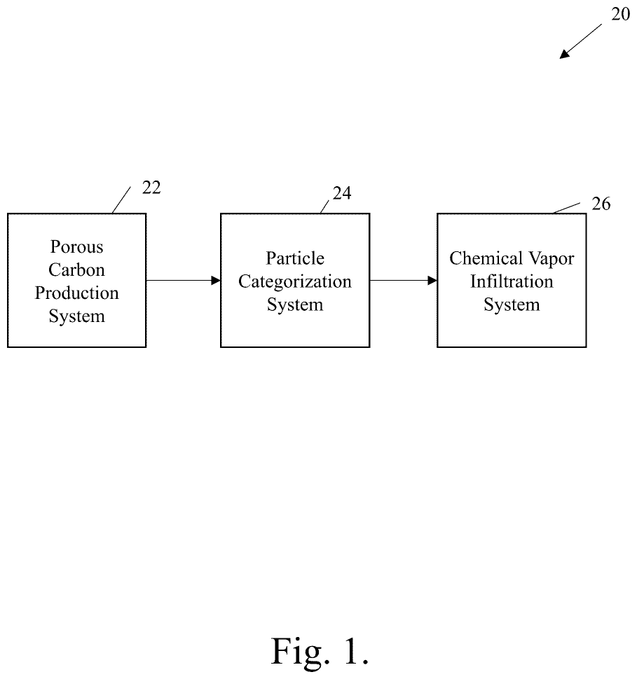

In various embodiments, as shown in FIG. 1, a system 20 is shown for producing a carbon material having an electrochemical modifier. The system 20 includes a porous carbon production system 22, a particle size characterization system 24, and a chemical vapor infiltration (CVI) system 26.

### A. Porous Scaffold Materials

For the purposes of embodiments of the current disclosure, a porous scaffold may be used, into which lithium is to be impregnated. In this context, the porous scaffold can comprise various materials. In some embodiments the porous scaffold material primarily comprises carbon, for example hard carbon. Other allotropes of carbon are also envisioned in other embodiments, for example, graphite, amorphous carbon, diamond, C60, carbon nanotubes (e.g., single and/or multi-walled), graphene and/or carbon fibers. The introduction of porosity into the carbon material can be achieved by a variety of means. For instance, the porosity in the carbon material can be achieved by modulation of polymer precursors, and/or processing conditions to create said porous carbon material, described in detail in the subsequent section.

In other embodiments, the porous scaffold comprises a polymer material. To this end, a wide variety of polymers are envisioned in various embodiments to have utility, including, but not limited to, inorganic polymers, organic polymers, and additional polymers. Examples of organic polymers includes, but are not limited to, sulfur-containing polymers such polysulfides and polysulfones, low density polyethylene (LDPE), high density polyethylene (HDPE), polypropylene (PP), polyvinyl chloride (PVC), polystyrene (PS), nylon, nylon 6, nylon 6,6, teflon (Polytetrafluoroethylene), thermoplastic polyurethanes (TPU), polyureas, poly(lactide), poly(glycolide) and combinations thereof, phenolic resins, polyamides, polyaramids, polyethylene terephthalate, polychloroprene, polyacrylonitrile, polyaniline, polyimide, poly(3,4-ethylenedioxythiophene) polystyrene sulfonate (PDOT:PSS), polymerized polydivinylbenzene, and others known in the arts. The organic polymer can be synthetic or natural in origin. In some embodiments, the polymer is a polysaccharide, such as sucrose, starch, cellulose, cellobiose, amylose, amylopectin, gum Arabic, lignin, and the like. In some embodiments, the polysaccharide is derived from the caramelization of mono- or oligomeric sugars, such as fructose, glucose, sucrose, maltose, raffinose, and the like.

In certain embodiments, the porous scaffold polymer material comprises a coordination polymer. Coordination polymers in this context include, but are not limited to, metal organic frameworks (MOFs). Techniques for production of MOFs, as well as exemplary species of MOFs, are known and described in the art (“The Chemistry and Applications of Metal-Organic Frameworks, Hiroyasu Furukawa et al. Science 341, (2013); DOI: 10.1126/science.1230444). Examples of MOFs in the context include, but are not limited to, Basolite™ materials and zeolitic imidazolate frameworks (ZIFs).

Concomitant with the myriad variety of polymers envisioned with the potential to provide a porous substrate, various processing approaches are envisioned in various embodiments to achieve said porosity. In this context, general methods for imparting porosity into various materials are myriad, as known in the art, including, but certainly not limited to, methods involving emulsification, micelle creation, gasification, dissolution followed by solvent removal (for example, lyophilization), axial compaction and sintering, gravity sintering, powder rolling and sintering, isostatic compaction and sintering, metal spraying, metal coating and sintering, metal injection molding and sintering, and the like. Other approaches to create a porous polymeric material, including creation of a porous gel, such as a freeze dried gel, aerogel, and the like are also envisioned.

In certain embodiments, the porous scaffold material comprises a porous ceramic material. In certain embodiments, the porous scaffold material comprises a porous ceramic foam. In this context, general methods for imparting porosity into ceramic materials are varied, as known in the art, including, but certainly not limited to, creation of porous In this context, general methods and materials suitable for comprising the porous ceramic include, but are not limited to, porous aluminum oxide, porous zirconia toughened alumina, porous partially stabilized zirconia, porous alumina, porous sintered silicon carbide, sintered silicon nitride, porous cordierite, porous zirconium oxide, clay-bound silicon carbide, and the like.

In certain embodiments, the porous material comprises a porous metal. Suitable metals in this regard include, but are not limited to porous aluminum, porous steel, porous nickel, porous Inconel, porous Hastelloy, porous titanium, porous copper, porous brass, porous gold, porous silver, porous germanium, and other metals capable of being formed into porous structures, as known in the art. In some embodiments, the porous scaffold material comprises a porous metal foam. The types of metals and methods to manufacture related to the same are known in the art. Such methods include, but are not limited to, casting (including foaming, infiltration, and lost-foam casting), deposition (chemical and physical), gas-eutectic formation, and powder metallurgy techniques (such as powder sintering, compaction in the presence of a foaming agent, and fiber metallurgy techniques).

### B. Porous Carbon Scaffold Materials

Methods for preparing porous carbon materials from polymer precursors are known in the art. For example, methods for preparation of carbon materials are described in U.S. Pat. Nos. 7,723,262, 8,293,818, 8,404,384, 8,654,507, 8,916,296, 9,269,502, 10,590,277, and U.S. patent application Ser. No. 16/745,197, the full disclosures of which are hereby incorporated by reference in their entireties for all purposes.

Accordingly, in one embodiment the present disclosure provides a method for preparing any of the carbon materials or polymer gels described above. The carbon materials may be synthesized through pyrolysis of either a single precursor, for example a saccharide material such as sucrose, fructose, glucose, dextrin, maltodextrin, starch, amylopectin, amylose, lignin, gum Arabic, and other saccharides known in the art, and combinations thereof. Alternatively, the carbon materials may be synthesized through pyrolysis of a complex resin, for instance formed using a sol-gel method using polymer precursors such as phenol, resorcinol, bisphenol A, urea, melamine, and other suitable compounds known in the art, and combinations thereof, in a suitable solvent such as water, ethanol, methanol, and other solvents known in the art, and combinations thereof, with cross-linking agents such as formaldehyde, hexamethylenetetramine, furfural, and other cross-linking agents known in the art, and combinations thereof. The resin may be acid or basic and may contain a catalyst. The catalyst may be volatile or non-volatile. The pyrolysis temperature and dwell time can vary as known in the art.

In some embodiments, the methods comprise preparation of a polymer gel by a sol gel process, condensation process or crosslinking process involving monomer precursor(s) and a crosslinking agent, two existing polymers and a crosslinking agent or a single polymer and a crosslinking agent, followed by pyrolysis of the polymer gel. The polymer gel may be dried (e.g., freeze dried) prior to pyrolysis; however, drying is not necessarily required.

The target carbon properties can be derived from a variety of polymer chemistries provided the polymerization reaction produces a resin/polymer with the necessary carbon backbone. Different polymer families include novolacs, resoles, acrylates, styrenes, urethanes, rubbers (neoprenes, styrene-butadienes, etc.), nylons, etc. The preparation of any of these polymer resins can occur via a number of different processes including sol gel, emulsion/suspension, solid state, solution state, melt state, etc. for either polymerization or crosslinking processes.

In some embodiments the reactant comprises phosphorus. In certain other embodiments, the phosphorus is in the form of phosphoric acid. In certain other embodiments, the phosphorus can be in the form of a salt, wherein the anion of the salt comprises one or more phosphate, phosphite, phosphide, hydrogen phosphate, dihydrogen phosphate, hexafluorophosphate, hypophosphite, polyphosphate, or pyrophosphate ions, or combinations thereof. In certain other embodiments, the phosphorus can be in the form of a salt, wherein the cation of the salt comprises one or more phosphonium ions. The non-phosphate containing anion or cation pair for any of the above embodiments can be chosen for those known and described in the art. In the context, exemplary cations to pair with phosphate-containing anions include, but are not limited to, ammonium, tetraethylammonium, and tetramethylammonium ions. In the context, exemplary anions to pair with phosphate-containing cations include, but are not limited to, carbonate, dicarbonate, and acetate ions.

In some embodiments, the reactant comprises sulfur. In certain other embodiments, the sulfur is in the form of sulfuric acid. In certain other embodiments, the sulfur can be in the form of a salt, wherein the anion of the salt comprises one or more sulfate, sulfite, bisulfide, bisulfite, hypothiocyanite, sulfonium, S-methylmethionine, thiocarbonate, thiocyanate, thiophosphate, thiosilicate, or trimethylsulfonium, or combinations thereof.

In some embodiments, the catalyst comprises a basic volatile catalyst. For example, in one embodiment, the basic volatile catalyst comprises ammonium carbonate, ammonium bicarbonate, ammonium acetate, ammonium hydroxide, or combinations thereof. In a further embodiment, the basic volatile catalyst is ammonium carbonate. In another further embodiment, the basic volatile catalyst is ammonium acetate.

In still other embodiments, the method comprises admixing an acid. In certain embodiments, the acid is a solid at room temperature and pressure. In some embodiments, the acid is a liquid at room temperature and pressure. In some embodiments, the acid is a liquid at room temperature and pressure that does not provide dissolution of one or more of the other polymer precursors.

In one embodiment a spherical polydivinylbencene spheres are produced by precipitation polymerization, pyrolyzed, and activated by the methods described herein.

In one embodiment, a porous carbon can be prepared by pyrolysis of a fluorine containing polymer (e.g., polyvinylidenine fluoride) by heating the material to 600 C under an inert gas such as nitrogen flowing in a horizontal tube furnace. The material was allowed to cool for 30 minutes and subsequently cooled to room temperature prior to removing from the furnace. The resulting carbonized material was attrition milled to less than 25-micron particle size distribution and used to prepare electrodes. The porous carbon prepared by this method is rich in fluorine which facilitates formation of lithium fluoride in the initial stage of electrochemical plating of the lithium metal in a lithium-ion battery, thereby increasing the lithiophilicity and reduces detrimental dendrite growth in the battery.

In certain embodiments, the polymer precursor components are blended together and subsequently held for a time and at a temperature sufficient to achieve polymerization. One or more of the polymer precursor components can have particle size less than about 20 mm in size, for example less than 10 mm, for example less than 7 mm, for example, less than 5 mm, for example less than 2 mm, for example less than 1 mm, for example less than 100 microns, for example less than 10 microns. In some embodiments, the particle size of one or more of the polymer precursor components is reduced during the blending process.

The blending of one or more polymer precursor components in the absence of solvent can be accomplished by methods described in the art, for example ball milling, jet milling, Fritsch milling, planetary mixing, and other mixing methodologies for mixing or blending solid particles while controlling the process conditions (e.g., temperature). The mixing or blending process can be accomplished before, during, and/or after (or combinations thereof) incubation at the reaction temperature.

Reaction parameters include aging the blended mixture at a temperature and for a time sufficient for the one or more polymer precursors to react with each other and form a polymer. In this respect, suitable aging temperature ranges from about room temperature to temperatures at or near the melting point of one or more of the polymer precursors. In some embodiments, suitable aging temperature ranges from about room temperature to temperatures at or near the glass transition temperature of one or more of the polymer precursors. For example, in some embodiments the solvent free mixture is aged at temperatures from about 20° C. to about 600° C., for example about 20° C. to about 500° C., for example about 20° C. to about 400° C., for example about 20° C. to about 300° C., for example about 20° C. to about 200° C. In certain embodiments, the solvent free mixture is aged at temperatures from about 50 to about 250° C.

The reaction duration is generally sufficient to allow the polymer precursors to react and form a polymer, for example the mixture may be aged anywhere from 1 hour to 48 hours, or more or less depending on the desired result. Typical embodiments include aging for a period of time ranging from about 2 hours to about 48 hours, for example in some embodiments aging comprises about 12 hours and in other embodiments aging comprises about 4-8 hours (e.g., about 6 hours).

In certain embodiments, an electrochemical modifier is incorporated during the above-described polymerization process. For example, in some embodiments, an electrochemical modifier in the form of metal particles, metal paste, metal salt, metal oxide or molten metal can be dissolved or suspended into the mixture from which the gel resin is produced.

Exemplary electrochemical modifiers for producing composite materials may fall into one or more than one of the chemical classifications. In some embodiments, the electrochemical modifier is a lithium salt, for example, but not limited to, lithium fluoride, lithium chloride, lithium carbonate, lithium hydroxide, lithium benzoate, lithium bromide, lithium formate, lithium hexafluorophosphate, lithium iodate, lithium iodide, lithium perchlorate, lithium phosphate, lithium sulfate, lithium tetraborate, lithium tetrafluoroborate, and combinations thereof.

In certain embodiments, the electrochemical modifier comprises a metal, and exemplary species includes, but are not limited to aluminum isopropoxide, manganese acetate, nickel acetate, iron acetate, tin chloride, silicon chloride, and combinations thereof. In certain embodiments, the electrochemical modifier is a phosphate compound, including but not limited to phytic acid, phosphoric acid, ammonium dihydrogen phosphate, and combinations thereof. In certain embodiments, the electrochemical modifier comprises silicon, and exemplary species includes, but are not limited to silicon powders, silicon nanotubes, polycrystalline silicon, nanocrystalline silicon, amorphous silicon, porous silicon, nano sized silicon, nano-featured silicon, nano-sized and nano-featured silicon, silicyne, and black silicon, and combinations thereof.

Electrochemical modifiers can be combined with a variety of polymer systems through either physical mixing or chemical reactions with latent (or secondary) polymer functionality. Examples of latent polymer functionality include, but are not limited to, epoxide groups, unsaturation (double and triple bonds), acid groups, alcohol groups, amine groups, basic groups. Crosslinking with latent functionality can occur via heteroatoms (e.g. vulcanization with sulfur, acid/base/ring opening reactions with phosphoric acid), reactions with organic acids or bases (described above), coordination to transition metals (including but not limited to Ti, Cr, Mn, Fe, Co, Ni, Cu, Zn, Zr, Nb, Mo, Ag, Au), ring opening or ring closing reactions (rotaxanes, spiro compounds, etc.).

Electrochemical modifiers can also be added to the polymer system through physical blending. Physical blending can include but is not limited to melt blending of polymers and/or co-polymers, the inclusion of discrete particles, chemical vapor deposition of the electrochemical modifier and co-precipitation of the electrochemical modifier and the main polymer material.

In some instances, the electrochemical modifier can be added via a metal salt solid, solution, or suspension. The metal salt solid, solution or suspension may comprise acids and/or alcohols to improve solubility of the metal salt. In yet another variation, the polymer gel (either before or after an optional drying step) is contacted with a paste comprising the electrochemical modifier. In yet another variation, the polymer gel (either before or after an optional drying step) is contacted with a metal or metal oxide sol comprising the desired electrochemical modifier.

In addition to the above exemplified electrochemical modifiers, the composite materials may comprise one or more additional forms (i.e., allotropes) of carbon. In this regard, it has been found that inclusion of different allotropes of carbon such as graphite, amorphous carbon, conductive carbon, carbon black, diamond, C60, carbon nanotubes (e.g., single and/or multi-walled), graphene and/or carbon fibers into the composite materials is effective to optimize the electrochemical properties of the composite materials. The various allotropes of carbon can be incorporated into the carbon materials during any stage of the preparation process described herein. For example, during the solution phase, during the gelation phase, during the curing phase, during the pyrolysis phase, during the milling phase, or after milling. In some embodiments, the second carbon form is incorporated into the composite material by adding the second carbon form before or during polymerization of the polymer gel as described in more detail herein. The polymerized polymer gel containing the second carbon form is then processed according to the general techniques described herein to obtain a carbon material containing a second allotrope of carbon.

In some embodiments, the polymer precursor is a polyvinylbenzene sphere produced by precipitation polymerization. In other embodiments, the polymer precursor in the low or essentially solvent free reaction mixture is a urea or an amine containing compound. For example, in some embodiments the polymer precursor is urea, melamine, hexamethylenetetramine (HMT) or combination thereof. Other embodiments include polymer precursors selected from isocyanates or other activated carbonyl compounds such as acid halides and the like.

Some embodiments of the disclosed methods include preparation of low or solvent-free polymer gels (and carbon materials) comprising electrochemical modifiers. Such electrochemical modifiers include, but are not limited to nitrogen, silicon, and sulfur. In other embodiments, the electrochemical modifier comprises fluorine, iron, tin, silicon, nickel, aluminum, zinc, or manganese. The electrochemical modifier can be included in the preparation procedure at any step. For example, in some the electrochemical modifier is admixed with the mixture, the polymer phase or the continuous phase.

The porous carbon material can be achieved via pyrolysis of a polymer produced from precursor materials as described above. In some embodiments, the porous carbon material comprises an amorphous activated carbon that is produced by pyrolysis, physical or chemical activation, or combination thereof in either a single process step or sequential process steps.

The temperature and dwell time of pyrolysis can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the pyrolysis temperature varies from 650° C. to 1100° C. The pyrolysis can be accomplished in an inert gas, for example nitrogen, or argon.

In some embodiments, an alternate gas is used to further accomplish carbon activation. In certain embodiments, pyrolysis and activation are combined. Suitable gases for accomplishing carbon activation include, but are not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the temperature for combined pyrolysis and activation varies from 650° C. to 1100° C.

In some embodiments, combined pyrolysis and activation is carried out to prepare the porous carbon scaffold. In such embodiments, the process gas can remain the same during processing, or the composition of process gas may be varied during processing. In some embodiments, the addition of an activation gas such as CO2, steam, or combination thereof, is added to the process gas following sufficient temperature and time to allow for pyrolysis of the solid carbon precursors.

Suitable gases for accomplishing carbon activation include, but are not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the activation temperature varies from 650° C. to 1100° C.

Before porous carbon scaffold particles are sent to CVI processing, the carbon is subjected to particle size reduction. The particle size reduction can be accomplished by a variety of techniques known in the art, for example by jet milling in the presence of various gases including air, nitrogen, argon, helium, supercritical steam, and other gases known in the art. Other particle size reduction methods, such as grinding, ball milling, water jet milling, and other approaches known in the art are also envisioned.

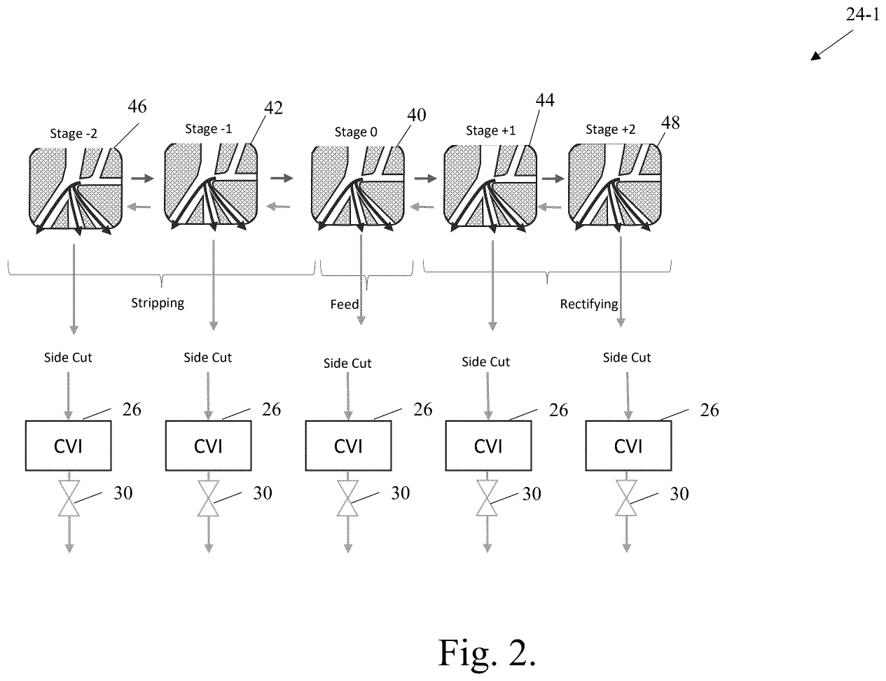

After particle size reduction, in various embodiments, as shown in FIG. 2, an exemplary five-stage particle categorization system 24-1 includes multiple particle classifiers 40-48 that separate the milled carbon particles (i.e., output from particle size reduction) into more defined size categories. The separated, milled, porous, activated carbon scaffold particles then undergo uniform CVI reaction at the CVI system 26, followed by a precise blending process to target a specific particle size distribution for target applications such as consumer devices, electric vehicles, etc. When porous, activated carbon scaffold particles of a uniform size undergo CVI, the silicon infiltration that occurs during CVI is also more uniform. Uniformity results when particles are more accurately separated more accurately by size and/or weight. Valves 30 may be manually or automatically controlled via handles or controller activated actuators (not shown) for selecting desired blends of silicon infused carbon produced by the CVI systems 26.

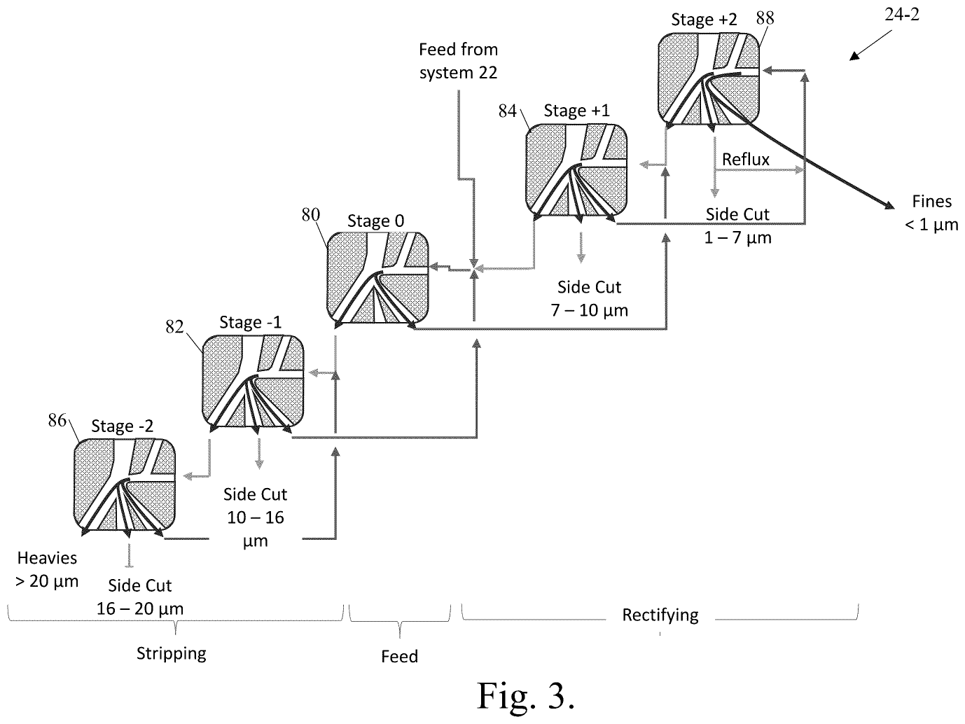

In various embodiments, as shown in FIG. 3, a five-stage particle categorization system 24-2 includes multiple elbow jet classifiers 80-88 used in series to form a separation column. Carbon fines and heavies are separated in a stage 0 elbow jet classifier 80 then fed to respective stage +1 and −1 elbow jet classifiers 82, 84. Carbon fines are lighter and smaller than the carbon heavies and side-cut products of the respective classifier. Median streams of the classifiers 82, 84 are taken as first and second side-cut products. The carbon heavies from the stage −1 classifier 82 are fed to the stage −2 classifier 86. The carbon fines from the stage −1 classifier 82 are fed to the stage 0 classifier 80 for reprocessing. The carbon fines from the stage +1 classifier 84 are fed to the stage +2 classifier 88. The carbon heavies from the stage +1 classifier 84 are fed to the stage 0 classifier 80 for reprocessing. A portion of the side cut output of the stage +2 classifier 88 is fed back through the stage +2 classifier 88 (i.e., reflux) for reprocessing. A portion of the side cut output of the stage −2 classifier 86 may be fed back through the stage −2 classifier 88 for reprocessing (i.e., recycle). The stage 0 classifier 80 is considered the feed portion of the separation column, the stage −1, −2 classifiers 82, 86 are considered the stripping portion of the separation column, and the stage +1, +2 are considered the rectifying portion of the separation column.

In various embodiments, the median stream output from the classifiers 82-88 may be any desired sizes or range of sizes. For example, the stage −2 classifier 86 may produce carbon heavies>20 μm and side cut=16-20 μm, stage −1 classifier 82 side cut=10-16 μm, the stage +1 classifier 84 side cut=7-10 μm, and the stage +2 classifier 88 side cut=1-7 μm and carbon fines<1μ. Carbon heavies may be returned to the milling device to bring them into a more classifiable range when received by the particle categorization system 24-2.

It can be appreciated that any number of stages may be used with particle stream recycle and reflux being performed at any of the classifier stages. Thus, it is conceivable that the side cut outputs may be tuned to target a specific size value and/or size range.

Example elbow-jet air classifiers are produced by Matsubo Corporation.

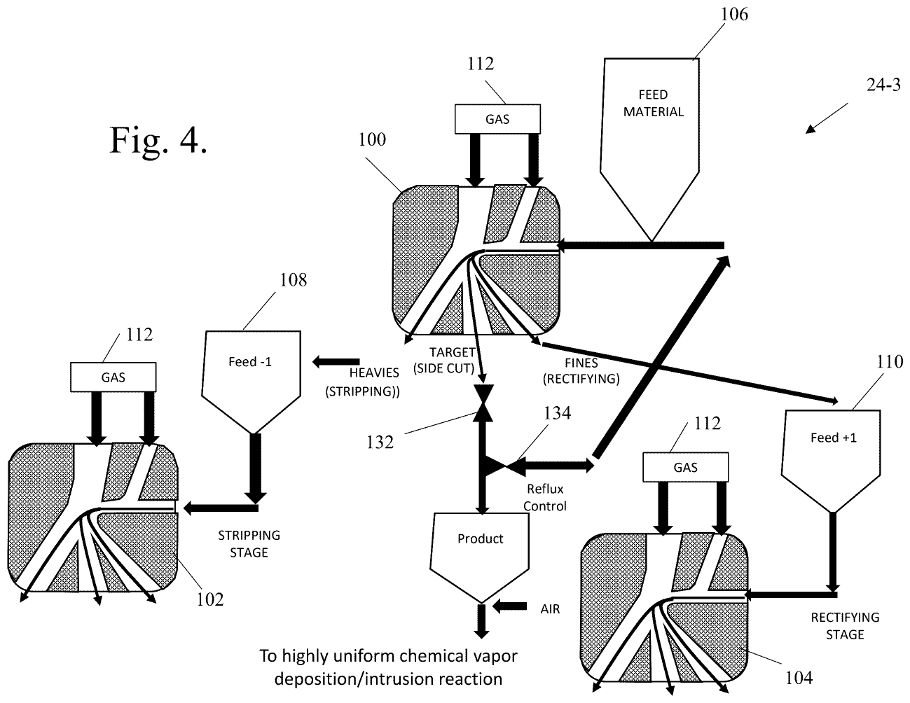

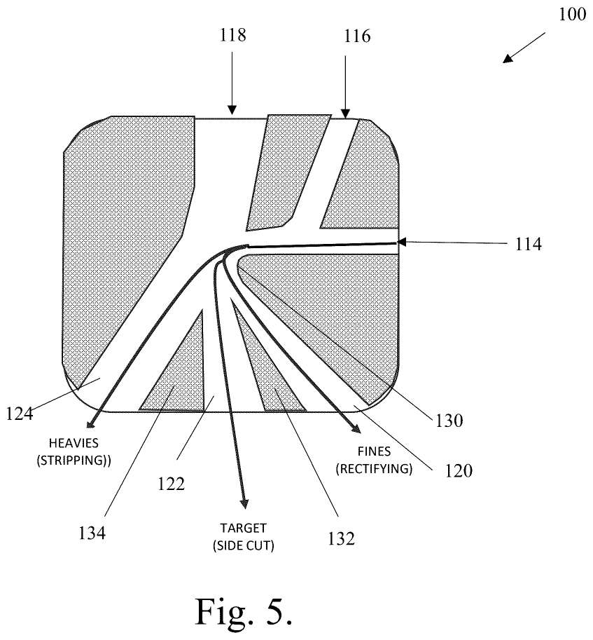

In various embodiments, as shown in FIGS. 4 and 5, an exemplary three-stage particle size characterization system 24-3 includes a plurality of elbow jet classifiers 100-104, a feed hopper 106, one or more cyclone hoppers 108, 110, and a pressurized gas source 112. The feed hopper 106 receives milled porous carbon material from the porous carbon production system 22. The milled porous carbon material is drawn into an entry port 114 of the first one of the elbow jet classifiers 100 with compressed gas (i.e., carrier gas) from the compressed gas source 116 via a first gas inlet port 116.

The first elbow jet classifier 100 separates particles into target diameter (side-cut) and off-target diameter (e.g., heavies and fines) using the Coanda Effect resulting from the carrier gas received via a second gas inlet port 118 as it adheres to a curved surface. Lighter/smaller particles (fines) get rejected at a fines exit port 120 due to gas flow adherence to a first edge 130. Particles having a target particle size exit the surface-adhering flow carrier gas to get ejected at a target exit port 122. Heavier/larger particles (heavies) exit the surface-adhering flow carrier gas even earlier to get rejected at a heavies exit port 124.

In various embodiments, the classifier may include only a single gas inlet port or more than two inlet ports.

Each stage may have a side cut, which could have flow regulated using a valve 132 following the side cut. The characterization system 24-3 may also include a reflux valve(s) 134 that sends a fraction of product or material from the side cut of the first elbow jet classifier 100 back into the first elbow jet classifier 100 for greater classification, thus improving uniformity and yield of the side-cut material (i.e., the target exit port 122).

In various embodiments, temperature and composition of the gas received at the ports 116, 118 may be varied to affect viscosity and density. For example, heavier particles could be separated with a dense gas, such as argon. A less dense gas, such as helium, could be used for separation of finer particles. Intermediate hoppers 108, 110 may be needed to disengage particles from gas stream, and to act is a buffer “tray” before the separation process of the next stage occurs. The carrier gas can be, but are not limited to helium, hydrogen, methane, nitrogen, neon, and argon.

In various embodiments, components (e.g., wedges 132, 134) of the elbow jet classifiers 100-104 are adjustable to alter where differently sized particles exit. Wedges 132, 134 may be moved to make passageways between each other or between walls of the classifiers various sizes. For example, the wedges 132, 134 may be moved so that they touch, thus avoiding a side-cut size classification. This configuration may be used for the stage 0 classifier 80 of FIG. 3.

The classifiers may include handles or control mechanisms to control particle separation, type of gas being used, carrier gas flow rate, temperature of the carrier gas, reflux quantity, and/or shutting of specific valves. These control mechanisms allow one to control particle separation at each separation stage.

Classified particles are deposited in the cyclone hoppers 108, 110 thereby disengaging the particles from the carrier gas. The cyclone hoppers 108, 110 also function as a buffer tank to regulate flow rate to the next stage. In various embodiments, the hoppers 106, 108, 110 are eliminated with the particles being fed directly from the previous operational stage.

The highly uniform particles output by the classifier systems above go to the CVI process in batches or continuously such as via a vibratory reactor. With a very uniform particle size, benefits in the batch or vibratory reaction for product consistency would be realized. Also, yield would be improved because less target sized particles would get wasted or thrown away and less out-of-target sized particles would be included in the outputted product.

After CVI, the various particle sizes could be reconstituted in a very particular way to create a desired particle size distribution. Including binodal, skewed, gaussian, or uniform.

The porous carbon scaffold may be in the form of particles. The particle size and particle size distribution can be measured by a variety of techniques known in the art and can be described based on fractional volume. In this regard, the Dv50 of the carbon scaffold may be between 10 nm and 10 mm, for example between 100 nm and 1 mm, for example between 1 μm and 100 μm, for example between 2 μm and 50 μm, example between 3 μm and 30 μm, example between 4 μm and 20 μm, example between 5 μm and 10 μm. In certain embodiments, the Dv50 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv100 is less than 1 mm, for example less than 100 μm for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv99 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv90 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv0 is greater than 10 nm, for example greater than 100 nm, for example greater than 500 nm, for example greater than 1 μm, for example greater than 2 μm, for example greater than 5 μm, for example greater than 10 μm. In certain embodiments, the Dv1 is greater than 10 nm, for example greater than 100 nm, for example greater than 500 nm, for example greater than 1 μm, for example greater than 2 μm, for example greater than 5 μm, for example greater than 10 μm. In certain embodiments, the Dv10 is greater than 10 nm, for example greater than 100 nm, for example greater than 500 nm, for example greater than 1 μm, for example greater than 2 μm, for example greater than 5 μm, for example greater than 10 μm.

In some embodiments, the surface area of the porous carbon scaffold can comprise a surface area greater than 400 m²/g, for example greater than 500 m²/g, for example greater than 750 m²/g, for example greater than 1000 m²/g, for example greater than 1250 m²/g, for example greater than 1500 m²/g, for example greater than 1750 m²/g, for example greater than 2000 m²/g, for example greater than 2500 m²/g, for example greater than 3000 m²/g. In other embodiments, the surface area of the porous carbon scaffold can be less than 500 m²/g. In some embodiments, the surface area of the porous carbon scaffold is between 200 and 500 m²/g. In some embodiments, the surface area of the porous carbon scaffold is between 100 and 200 m²/g. In some embodiments, the surface area of the porous carbon scaffold is between 50 and 100 m²/g. In some embodiments, the surface area of the porous carbon scaffold is between 10 and 50 m²/g. In some embodiments, the surface area of the porous carbon scaffold can be less than 10 m²/g. Physical adsorption of a known gas, i.e., BET (Brunauer-Emmett-Teller) is an exemplary method for measuring surface area. BET primarily uses nitrogen or CO₂, but other gasses can be used as well. Gravimetrically via dynamic vapor sorption is another exemplary method for measuring surface area, that uses materials such as SO₂, CO₂, Ar, Toluene, Ethanol, and other materials.

In some embodiments, the pore volume of the porous carbon scaffold is greater than 0.4 cm³/g, for example greater than 0.5 cm³/g, for example greater than 0.6 cm³/g, for example greater than 0.7 cm³/g, for example greater than 0.8 cm³/g, for example greater than 0.9 cm³/g, for example greater than 1.0 cm³/g, for example greater than 1.1 cm³/g, for example greater than 1.2 cm³/g, for example greater than 1.4 cm³/g, for example greater than 1.6 cm³/g, for example greater than 1.8 cm³/g, for example greater than 2.0 cm³/g. In other embodiments, the pore volume of the porous carbon scaffold is less than 0.5 cm³, for example between 0.1 cm³/g and 0.5 cm³/g. In certain other embodiments, the pore volume of the porous carbon scaffold is between 0.01 cm³/g and 0.1 cm³/g.

Various methods for measuring pore volume currently exist. They include mercury porosimetry, BET that uses various gasses including He, N₂, CO₂, other adsorption isotherms using density functional theory (DFT) and non-local density functional theory (NLDFT). Pycnometry using helium and other gases, water immersion porosimetry, scanning electron microscopy, atomic force microscopy, tunneling electron microscopy, x-ray scattering, and small angle neutron scattering may also be used.

In some other embodiments, the porous carbon scaffold is an amorphous activated carbon with a pore volume between 0.2 and 2.0 cm³/g. In certain embodiments, the carbon is an amorphous activated carbon with a pore volume between 0.4 and 1.5 cm³/g. In certain embodiments, the carbon is an amorphous activated carbon with a pore volume between 0.5 and 1.2 cm³/g. In certain embodiments, the carbon is an amorphous activated carbon with a pore volume between 0.6 and 1.0 cm³/g.

In some other embodiments, the porous carbon scaffold comprises a tap density of less than 1.0 g/cm³, for example less than 0.8 g/cm³, for example less than 0.6 g/cm³, for example less than 0.5 g/cm³, for example less than 0.4 g/cm³, for example less than 0.3 g/cm³, for example less than 0.2 g/cm³, for example less than 0.1 g/cm³.

The surface functionality of the porous carbon scaffold can vary. One property which can be predictive of surface functionality is the pH of the porous carbon scaffold. The presently disclosed porous carbon scaffolds comprise pH values ranging from less than 1 to about 14, for example less than 5, from 5 to 8 or greater than 8. In some embodiments, the pH of the porous carbon is less than 4, less than 3, less than 2 or even less than 1. In other embodiments, the pH of the porous carbon is between about 5 and 6, between about 6 and 7, between about 7 and 8 or between 8 and 9 or between 9 and 10. In still other embodiments, the pH is high and the pH of the porous carbon ranges is greater than 8, greater than 9, greater than 10, greater than 11, greater than 12, or even greater than 13.

The pore volume distribution of the porous carbon scaffold can vary. For example, the percentage (%) micropores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable micropore volume in the porous carbon scaffold.

The mesopores comprising the porous carbon scaffold can vary. For example, the % mesopores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable mesopore volume in the porous carbon scaffold.

In some embodiments, the pore volume distribution of the porous carbon scaffold comprises more than 50% macropores, for example more than 60% macropores, for example more than 70% macropores, for example more than 80% macropores, for example more than 90% macropores, for example more than 95% macropores, for example more than 98% macropores, for example more than 99% macropores, for example more than 99.5% macropores, for example more than 99.9% macropores.

In certain preferred embodiments, the pore volume of the porous carbon scaffold comprises a blend of micropores, mesopores, and macropores. Accordingly, in certain embodiments, the porous carbon scaffold comprises 0-20% micropores, 30-70% mesopores, and less than 10% macropores. In certain other embodiments, the porous carbon scaffold comprises 0-20% micropores, 0-20% mesopores, and 70-95% macropores. In certain other embodiments, the porous carbon scaffold comprises 20-50% micropores, 50-80% mesopores, and 0-10% macropores. In certain other embodiments, the porous carbon scaffold comprises 40-60% micropores, 40-60% mesopores, and 0-10% macropores. In certain other embodiments, the porous carbon scaffold comprises 80-95% micropores, 0-10% mesopores, and 0-10% macropores. In certain other embodiments, the porous carbon scaffold comprises 0-10% micropores, 30-50% mesopores, and 50-70% macropores. In certain other embodiments, the porous carbon scaffold comprises 0-10% micropores, 70-80% mesopores, and 0-20% macropores. In certain other embodiments, the porous carbon scaffold comprises 0-20% micropores, 70-95% mesopores, and 0-10% macropores. In certain other embodiments, the porous carbon scaffold comprises 0-10% micropores, 70-95% mesopores, and 0-20% macropores.

In certain embodiments, the % of pore volume in the porous carbon scaffold representing pores between 100 and 1000 A (10 and 100 nm) comprises greater than 30% of the total pore volume, for example greater than 40% of the total pore volume, for example greater than 50% of the total pore volume, for example greater than 60% of the total pore volume, for example greater than 70% of the total pore volume, for example greater than 80% of the total pore volume, for example greater than 90% of the total pore volume, for example greater than 95% of the total pore volume, for example greater than 98% of the total pore volume, for example greater than 99% of the total pore volume, for example greater than 99.5% of the total pore volume, for example greater than 99.9% of the total pore volume.

In certain embodiments, the pycnometry density of the porous carbon scaffold ranges from about 1 g/cc to about 3 g/cc, for example from about 1.5 g/cc to about 2.3 g/cc. In other embodiments, the skeletal density ranges from about 1.5 cc/g to about 1.6 cc/g, from about 1.6 cc/g to about 1.7 cc/g, from about 1.7 cc/g to about 1.8 cc/g, from about 1.8 cc/g to about 1.9 cc/g, from about 1.9 cc/g to about 2.0 cc/g, from about 2.0 cc/g to about 2.1 cc/g, from about 2.1 cc/g to about 2.2 cc/g or from about 2.2 cc/g to about 2.3 cc/g, from about 2.3 cc to about 2.4 cc/g, for example from about 2.4 cc/g to about 2.5 cc/g.

In some embodiments, the carbon scaffold pore volume distribution can be described as the number or volume distribution of pores as determined as known in the art based on gas sorption analysis, for example nitrogen gas sorption analysis. In some embodiments the pore size distribution can be expressed in terms of the pore size at which a certain fraction of the total pore volume resides at or below. For example, the pore size at which 10% of the pores reside at or below can be expressed as Dv,10.

The Dv,10 for the porous carbon scaffold can vary, for example Dv,10 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm.

The Dv,50 for the porous carbon scaffold can vary, for example Dv,50 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm. In other embodiments, the Dv,50 is between 2 and 100, for example between 2 and 50, for example between 2 and 30, for example between 2 and 20, for example between 2 and 15, for example between 2 and 10.

The Dv,90 for the porous carbon scaffold can vary, for example Dv,90 can be between 0.01 nm and 100 nm, for example between 0.1 nm and 100 nm, for example between 1 nm and 100 nm, for example between 1 nm and 50 nm, for example between 1 nm and 50 nm, for example between 1 nm and 40 nm, for example between 1 nm and 30 nm, for example between 1 nm and 10 nm, for example between 1 nm and 5 nm. In other embodiments, the Dv,50 is between 2 nm and 100 nm, for example between 2 nm and 50 nm, for example between 2 nm and 30 nm, for example between 2 nm and 20 nm, for example between 2 nm and 15 nm, for example between 2 nm and 10 nm.

In some embodiments, the Dv,90 is less than 100 nm, for example less than 50 nm, for example less than 40 nm, for example less than 30 nm, for example less than 20 nm, for example less than 15 nm, for example less than 10 nm. In some embodiments, the carbon scaffold comprises a pore volume with greater than 70% micropores (and Dv,90 less than 100 nm, for example Dv,90 less than 50 nm, for example Dv,90 less than 40 nm, for example Dv,90 less than 30 nm, for example Dv,90 less than 20 nm, for example Dv,90 less than 15 nm, for example Dv,90 less than 10 nm, for example Dv,90 less than 5 nm, for example Dv,90 less than 4 nm, for example Dv,90 less than 3 nm. In other embodiments, the carbon scaffold comprises a pore volume with greater than 80% micropores and Dv,90 less than 100 nm, for example Dv,90 less than 50 nm, for example Dv,90 less than 40 nm, for example Dv,90 less than 30 nm, for example Dv,90 less than 20 nm, for example Dv,90 less than 15 nm, for example Dv,90 less than 10 nm, for example Dv,90 less than 5 nm, for example Dv,90 less than 4 nm, for example Dv,90 less than 3 nm.

The Dv,99 for the porous carbon scaffold can vary, for example Dv,99 can be between 0.01 nm and 1000 nm, for example between 0.1 nm and 1000 nm, for example between 1 nm and 500 nm, for example between 1 nm and 200 nm, for example between 1 nm and 150 nm, for example between 1 nm and 100 nm, for example between 1 nm and 50 nm, for example between 1 nm and 20 nm. In other embodiments, the Dv,99 is between 2 nm and 500 nm, for example between 2 nm and 200 nm, for example between 2 nm and 150 nm, for example between 2 nm and 100 nm, for example between 2 nm and 50 nm, for example between 2 nm and 20 nm, for example between 2 nm and 15 nm, for example between 2 nm and 10 nm.

In certain embodiments, the carbon scaffold is modified prior to impregnation of lithium. For example, in certain embodiments, the surface of the carbon pores is functionalized for the purpose of creating a more lithiophilic surface, i.e., surface that interacts preferentially with lithium or lithium containing precursor materials, wherein said preferential interaction can manifest as preferential diffusion, deposition, adsorption of the like.

In some embodiments metal oxides are used to functionalize the porous carbon and improve lithiophilicity and thereby improve SEI stability of a lithium metal anode. In this embodiment, a porous carbon scaffold is modified with zinc oxide via a hydrothermal sol-gel synthesis reaction. Zinc acetate dihydrate is dissolved in water and stirred with micronized porous carbon powder. A strong oxidizing agent such as NaOH is then added dropwise into the reaction solution and allowed to react for up to 2 hours, before being separated by filtration and allowed to dry. In some embodiments the metal oxide may be aluminum oxide, nickel oxide, manganese oxide, cobalt oxide, tin oxide, or titanium oxide.

In still further embodiments the metal oxide is deposited via atomic layer deposition, physical vapor deposition onto the porous carbon surface and then subsequently converted to a metal oxide via chemical or thermal oxidation reactions. In still further embodiments, the porous carbon may be coated with a polymer containing lithium.

C. Introduction of Silicon into Scaffold Materials to Create Composite Materials

Nano-sized silicon is difficult to handle and to process in traditional electrodes. Due to the high surface area and preference to agglomerate, uniform dispersion and coating requires special procedures and/or binder systems. To truly be a drop-in replacement for existing graphite anode materials, the next generation Si—C material needs to be micron-sized. In a preferred embodiment, the size distribution for the composite is relatively uniform, with upper and lower bounds within a preferred range, for example, Dv,10 of no less than 5 nm, a Dv,50 between 500 nm and 5 μm, and a Dv,90 no greater than 50 μm. In certain embodiments, the composite particles/materials are comprised of the following size distribution: Dv,10 of no less than 50 nm, a Dv,50 between 1 μm and 10 μm, and a Dv,90 no greater than 30 μm. In certain other embodiments, the composite particles are comprised of the following size distribution: Dv,10 of no less than 100 nm, a Dv,50 between 2 μm and 8 μm, and a Dv,90 no greater than 20 μm. In certain further embodiments, the composite particles are comprised of the following size distribution: Dv,10 of no less than 250 nm, a Dv,50 between 4 μm and 6 μm, and a Dv,90 no greater than 15 μm.

Unlike existing composite materials which bury silicon into a mass of inactive material, it is understood that to achieve optimal performance, silicon needs room to expand and contract. In certain embodiments high pore volume carbons serve as porous scaffolds in which to embed or deposit silicon, and do so in an engineered fashion, filling pore volume of desired range to create impregnated carbon material of the desired size range. Thus, the scaffold, for example the porous carbon material, plays an important role as a framework and engineered in-situ control for expansion and contraction of the material as well as contributing to the overall electron and ion conduction capability of the composite particle. This scaffold structure allows for the movement of electrons and ions. The primary role of the scaffold is to a framework to affix the silicon to a single location and volume, allowing the silicon to outwardly expand and contract while remaining lodged inside the pores of the carbon scaffold material.

In certain embodiments, the silicon is introduced into the porous carbon by nanoparticle impregnation by the CVI system 26 of FIG. 1. Accordingly, a nano-sized or nano-sized and nano-featured silicon is first produced. In a preferred embodiment, the nano-sized and nano-featured silicon (individually or collectively “nano silicon”) is produced according to methods described in U.S. Pat. No. 10,147,950 “Materials With Extremely Durable Intercalation Of Lithium And Manufacturing Methods Thereof,” and/or U.S. Pat. No. 11,611,073 “Composites of Porous Nano-Featured Silicon Materials and Carbon Materials,” the full disclosures of which are hereby incorporated by reference in their entireties for all purposes.

The porous carbon can be mixed with the nano silicon, for example in a stirred reactor vessel wherein the carbon particles, for example micro sized porous carbon particles, are co-suspended with nano silicon of the desired particle size. The suspension milieu can be varied as known in the art, for example can be aqueous or non-aqueous. In certain embodiments, the suspension fluid can be multi-component, comprising either miscible or non-miscible co-solvents. Suitable co-solvents for aqueous (water) milieu include, but are not limited to, acetone, ethanol, methanol, and others known in the art. A wide variety of non-water-soluble milieu are also known in the art, including, but not limited to, heptane, hexane, cyclohexane, oils, such as mineral oils, vegetable oils, and the like. Without being bound by theory, mixing within the reactor vessel allows for diffusion of the silicon nanoparticles within the porous carbon particle. The resulting nano silicon impregnated carbon particles can then be harvested, for example, by centrifugation, filtration, and subsequent drying, all as known in the art.

To this end, the porous carbon particles with the desired extent and type of porosity are subject to processing that results in creation of silicon within said porosity. For this processing, the porous carbon particles can be first particle size reduced, for example to provide a Dv,50 between 1 and 1000 microns, for example between 1 and 100 microns, for example between 1 and 50 microns, for example between 1 and 20 microns, for example between 1 and 15 microns, for example between 2 and 12 microns, for example between 5 and 10 microns. The particle size reduction can be carried out as known in the art, and as described elsewhere herein, for instance by jet milling.

In a preferred embodiment, silicon is created within the pores of the porous carbon by subjecting the porous carbon particles to silane gas at elevated temperature and the presence of a silicon-containing gas, preferably silane, in order to achieve silicon deposition via chemical vapor deposition (CVD). The silane gas can be mixed with other inert gases, for example, nitrogen gas. The temperature and time of processing can be varied, for example the temperature can be between 30° and 400° C., for example between 40° and 500° C., for example between 50° and 600° C., for example between 60° and 700° C., for example between 70° and 800° C., for example between 80° and 900° C. The mixture of gas can comprise between 0.1 and 1% silane and remainder inert gas. Alternatively, the mixture of gas can comprise between 1% and 10% silane and the remainder inert gas. Alternatively, the mixture of gas can comprise between 10% and 20% silane and remainder inert gas. Alternatively, the mixture of gas can comprise between 20% and 50% silane and remainder inert gas. Alternatively, the mixture of gas can comprise above 50% silane and remainder inert gas. Alternatively, the gas can essentially be 100% silane gas. The reactor in which the CVD process is carried out is according to various designs as known in the art, for example in a fluid bed reactor, a static bed reactor, an elevator kiln, a rotary kiln, a box kiln, or other suitable reactor type. The reactor materials are suitable for this task, as known in the art. In a preferred embodiment, the porous carbon particles are processed under conditions that provide uniform access to the gas phase, for example a reactor wherein the porous carbon particles are fluidized, or otherwise agitated to provide said uniform gas access.

In some embodiments, the CVD process is a plasma-enhanced chemical vapor deposition (PECVD) process. This process is known in the art to provide utility for depositing thin films from a gas state (vapor) to a solid state on a substrate. Chemical reactions are involved in the process, which occurs after creation of a plasma of the reacting gases. The plasma is generally created by RF (AC) frequency or DC discharge between two electrodes, the space between which is filled with the reacting gases. In certain embodiments, the PECVD process is utilized for porous carbon that is coated on a substrate suitable for the purpose, for example a copper foil substrate. The PECVD can be carried out at various temperatures, for example between 30° and 800° C., for example between 30° and 600° C., for example between 30° and 500° C., for example between 30° and 400° C., for example at 350° C. The power can be varied, for example 25W RF, and the silane gas flow required for processing car be varied, and the processing time can be varied as known in the art.

The silicon that is impregnated into the porous carbon, regardless of the process, is envisioned to have certain properties that are optimal for utility as an energy storage material. For example, the size and shape of the silicon can be varied accordingly to match, while not being bound by theory, the extent and nature of the pore volume within the porous carbon particle. For example, the silicon can be impregnated, deposited by CVD, or other appropriate process into pores within the porous carbon particle comprising pore sizes between 5 nm and 1000 nm, for example between 10 nm and 500 nm, for example between 10 nm and 200 nm, for example between 10 nm and 100 nm, for example between 33 nm and 150 nm, for example between 20 nm and 100 nm. Other ranges of carbon pores sizes with regards to fractional pore volume, whether micropores, mesopores, or macropores, are also envisioned as described elsewhere within this disclosure.

The oxygen content in silicon can be less than 50%, for example, less than 30%, for example less than 20%, for example less than 15%, for example, less than 10%, for example, less than 5%, for example, less than 1%, for example less than 0.1%. In certain embodiments, the oxygen content in the silicon is between 1 and 30%. In certain embodiments, the oxygen content in the silicon is between 1 and 20%. In certain embodiments, the oxygen content in the silicon is between 1 and 10%. In certain embodiments, the oxygen content in the porous silicon materials is between 5 and 10%.

In certain embodiments wherein the silicon contains oxygen, the oxygen is incorporated such that the silicon exists as a mixture of silicon and silicon oxides of the general formula SiOx, where X is a non-integer (real number) can vary continuously from 0.01 to 2. In certain embodiments, the fraction of oxygen present on the surface of the nano-feature porous silicon is higher compared to the interior of the particle.

In certain embodiments, the silicon comprises crystalline silicon. In certain embodiments, the silicon comprises polycrystalline silicon. In certain embodiments, the silicon comprises micro-polycrystalline silicon. In certain embodiments, the silicon comprises nano-polycrystalline silicon. In certain other embodiments, the silicon comprises amorphous silicon. In certain other embodiments, the silicon comprises both crystalline and non-crystalline silicon.

In certain embodiments, the carbon scaffold to be impregnated or otherwise embedded with silicon can comprise various carbon allotropes and/or geometries. To this end, the carbon scaffold to be impregnated or otherwise embedded with silicon can comprise graphite, nano graphite, graphene, nano graphene, conductive carbon such as carbon black, carbon nanowires, carbon nanotubes, and the like, and combinations thereof.

In certain embodiments, the carbon scaffold that is impregnated or otherwise embedded with silicon is removed to yield the templated silicon material with desired size characteristics. The removal of the scaffold carbon can be achieved as known in the art, for example by thermal of chemical activation under conditions wherein the silicon does not undergo undesirable changes in its electrochemical properties. Alternatively, if the scaffold is a porous polymer or other material soluble in a suitable solvent, the scaffold can be removed by dissolution.

### EXAMPLES

Example 1. Properties of various carbon scaffold materials. The properties of various carbon scaffold materials are presented in Table 3. The exemplary carbon materials vary in properties such as total pore volume (for example varying from 0.5 to greater than 2 cm³/g, and also varying percentages of micro-, meso- and macropores.

TABLE 1
Properties of various carbon scaffold materials.

| Carbon | Surface | Pore | % | % | % |
|---|---|---|---|---|---|
| Scaffold | Area | Volume | Micro- | Meso- | Macro- |
| # | (m²/g) | (cm³/g) | pores | pores | pores |
| 1 | 1710 | 0.762 | 93.1 | 6.8 | 0.1 |
| 2 | 1744 | 0.72 | 97.2 | 2.7 | 0.1 |
| 3 | 1581 | 0.832 | 69.1 | 30.9 | 0.1 |
| 4 | 1710 | 0.817 | 80.1 | 19.9 | 0 |
| 5 | 1835 | 0.9 | 82.2 | 17.8 | 0 |
| 6 | 1475 | 1.06 | 52.4 | 47.6 | 0 |
| 7 | 453 | 0.5 | 3.9 | 91.1 | 5.1 |
| 8 | 787 | 2.284 | 0 | 59.1 | 40.9 |
| 9 | 1713 | 0.76 | 91 | 9 | 0 |

Example 2. Multi-stage carbon particle classification. A plurality of classifiers may classify received porous, pyrolyzed, activated carbon into any desired sizes or range of sizes, see for example Table 2.

TABLE 2
Classified carbon scaffold materials

| 1^{st} Range | 2^{nd} Range | 3^{rd} Range | 4^{th} Range | 5^{th} Range | | 6^{th} Range |
|---|---|---|---|---|---|---|
| 15-20 μm | 10-15 μm | 7-10 μm | 1-7 μm | <1 | μm | >20 μm |
| 12-18 μm | 9-12 μm | 6-9 μm | 2-6 μm | <2 | μm | >18 μm |
| 18-20 μm | 12-18 μm | 8-12 μm | 4-8 μm | <4 | μm | >20 μm |
| 18-20 μm | 12-18 μm | 8-12 μm | 4-8 μm | 1-4 | μm | <1 μm |

### EXPRESSED EMBODIMENTS

Embodiment 1. A method comprising: classifying pyrolyzed, activated carbon particles using a multi-stage classification system to produce multiple size classes of pyrolyzed, activated carbon particles; and separately infiltrating pores of each size class of the pyrolyzed, activated carbon particles with an electrochemical modifier to form a plurality of uniformly sized composite particles.

Embodiment 2. The method of embodiment 1, further comprising blending the uniformly sized composite particles from two or more of the plurality of uniformly sized composite particles based on a predefined specification.

Embodiment 3. The method of embodiment 1, wherein classifying further comprises: sending the pyrolyzed, activated carbon particles through a plurality of elbow jet classifiers.

Embodiment 4. The method of embodiment 3, wherein sending comprises: separating the pyrolyzed, activated carbon particles into a first target size range and one or more non-target size ranges at a first elbow jet classifier; sending the pyrolyzed, activated carbon particles associated with a first one of the non-target size ranges to a second elbow jet classifier; separating the pyrolyzed, activated carbon particles into a second target size range and one or more non-target size ranges at the second elbow jet classifier; sending the pyrolyzed, activated carbon particles associated with a second one of the non-target size ranges from the first classifier to a third elbow jet classifier; and separating the pyrolyzed, activated carbon particles into a third target size range and one or more non-target size ranges at the third elbow jet classifier.

Embodiment 5. The method of embodiment 4, wherein sending further comprises: at the second elbow jet classifier, sending the pyrolyzed, activated carbon particles associated with a third one of the non-target size ranges to the first elbow jet classifier for reprocessing; and at the third elbow jet classifier, sending the pyrolyzed, activated carbon particles associated with a fourth one of the non-target size ranges to the first elbow jet classifier for reprocessing.

Embodiment 6. The method of embodiment 4, wherein classifying further comprises: refluxing at least a portion of the pyrolyzed, activated carbon particles associated with any of the size ranges at any of the elbow jet classifiers.

Embodiment 7. The method of embodiment 4, further comprising: at an n^{th} elbow jet classifier, separating the pyrolyzed, activated carbon particles into an additional target size range and one or more additional non-target size ranges, where n represents an integer greater than three; and sending the pyrolyzed, activated carbon particles associated with one of the additional non-target size ranges to one of the first, second, third, or n^{th} elbow jet classifiers.

Embodiment 8. A system comprising: a porous carbon production system configured to produce pyrolyzed, activated carbon particles; a multi-stage classification system configured to separate the pyrolyzed, activated carbon particles into multiple size classes; and a chemical vapor infiltration system configured separately infiltrate pores of at least one of the size classes of the pyrolyzed, activated carbon particles with an electrochemical modifier to form at least one uniformly sized composite particles.

Embodiment 9. The system of embodiment 8, further comprising a blending device configured to blend the uniformly sized composite particles from two or more of the size classes based on a predefined specification.

Embodiment 10. The system of embodiment 8, wherein the multi-stage classification system comprises a plurality of elbow jet classifiers.

Embodiment 11. The system of embodiment 10, wherein the plurality of elbow jet classifiers comprises: a first elbow jet classifier configured to separate the pyrolyzed carbon particles into a first target size range and one or more non-target size ranges; a second elbow jet classifier configured to: receive the pyrolyzed carbon particles associated with a first one of the non-target size ranges from the first elbow jet classifier; and separate the pyrolyzed carbon particles into a second target size range and one or more non-target size ranges; and a third elbow jet classifier configured to: receive the pyrolyzed carbon particles associated with a second one of the non-target size ranges from the first elbow jet classifier; and separate the pyrolyzed carbon particles into a third target size range and one or more non-target size ranges.

Embodiment 12. The system of embodiment 11, wherein: the second elbow jet classifier is further configured to send the pyrolyzed carbon particles associated with a third one of the non-target size ranges to the first elbow jet classifier for reprocessing; and the third elbow jet classifier is further configured to send the pyrolyzed carbon particles associated with a fourth one of the non-target size ranges to the first elbow jet classifier for reprocessing.

Embodiment 13. The system of embodiment 11, wherein one or more of the elbow jet classifiers comprises a reflux device configured to reprocess a portion of the pyrolyzed carbon particles associated with any of the target size ranges.

Embodiment 14. The system of embodiment 10, further comprising one or more hoppers configured to receive pyrolyzed carbon particles to be fed to one or more of the elbow jet classifiers.

Embodiment 15. The system of embodiment 14, wherein the one or more hoppers comprise one or more cyclone hoppers.

Embodiment 16. A particle classification system comprising: a plurality of elbow jet classifiers configured to separate pyrolyzed, activated carbon particles into multiple size classes.

Embodiment 17. The system of embodiment 16, wherein the plurality of elbow jet classifiers comprises: a first elbow jet classifier configured to separate the pyrolyzed carbon particles into a first target size range and one or more non-target size ranges; a second elbow jet classifier configured to: receive the pyrolyzed carbon particles associated with a first one of the non-target size ranges from the first elbow jet classifier; and separate the pyrolyzed carbon particles into a second target size range and one or more non-target size ranges; and a third elbow jet classifier configured to: receive the pyrolyzed carbon particles associated with a second one of the non-target size ranges from the first elbow jet classifier; and separate the pyrolyzed carbon particles into a third target size range and one or more non-target size ranges.

Embodiment 18. The system of embodiment 17, wherein: the second elbow jet classifier is further configured to send the pyrolyzed carbon particles associated with a third one of the non-target size ranges to the first elbow jet classifier for reprocessing; and the third elbow jet classifier is further configured to send the pyrolyzed carbon particles associated with a fourth one of the non-target size ranges to the first elbow jet classifier for reprocessing.

Embodiment 19. The system of embodiment 17, wherein one or more of the elbow jet classifiers comprises a reflux device configured to reprocess a portion of the pyrolyzed carbon particles associated with the target size range.

Embodiment 20. The system of embodiment 16, further comprising one or more hoppers configured to receive pyrolyzed carbon particles to be fed to one or more of the elbow jet classifiers.

Embodiment 21. The system of embodiment 20, wherein the one or more hoppers comprise one or more cyclone hoppers.

From the foregoing it will be appreciated that, although specific embodiments of the disclosure have been described herein for purposes of illustration, various modifications may be made without deviating from the spirit and scope of the disclosure.

1. A method comprising:
classifying pyrolyzed, activated carbon particles using a multi-stage classification system to produce multiple size classes of pyrolyzed, activated carbon particles; and
separately infiltrating pores of each size class of the pyrolyzed, activated carbon particles with an electrochemical modifier to form a plurality of uniformly sized composite particles.

2. The method of claim 1, further comprising blending the uniformly sized composite particles from two or more of the plurality of uniformly sized composite particles based on a predefined specification.

3. The method of claim 1, wherein classifying further comprises:
sending the pyrolyzed, activated carbon particles through a plurality of elbow jet classifiers.

4. The method of claim 3, wherein sending comprises:
separating the pyrolyzed, activated carbon particles into a first target size range and one or more non-target size ranges at a first elbow jet classifier;
sending the pyrolyzed, activated carbon particles associated with a first one of the non-target size ranges to a second elbow jet classifier;
separating the pyrolyzed, activated carbon particles into a second target size range and one or more non-target size ranges at the second elbow jet classifier;
sending the pyrolyzed, activated carbon particles associated with a second one of the non-target size ranges from the first classifier to a third elbow jet classifier; and separating the pyrolyzed, activated carbon particles into a third target size range and one or more non-target size ranges at the third elbow jet classifier.

5. The method of claim 4, wherein sending further comprises:
at the second elbow jet classifier, sending the pyrolyzed, activated carbon particles associated with a third one of the non-target size ranges to the first elbow jet classifier for reprocessing; and
at the third elbow jet classifier, sending the pyrolyzed, activated carbon particles associated with a fourth one of the non-target size ranges to the first elbow jet classifier for reprocessing.

6. The method of claim 4, wherein classifying further comprises:
refluxing at least a portion of the pyrolyzed, activated carbon particles associated with any of the size ranges at any of the elbow jet classifiers.

7. The method of claim 4, further comprising:
at an n^{th} elbow jet classifier, separating the pyrolyzed, activated carbon particles into an additional target size range and one or more additional non-target size ranges, where n represents an integer greater than three; and
sending the pyrolyzed, activated carbon particles associated with one of the additional non-target size ranges to one of the first, second, third, or n^{th} elbow jet classifiers.

8. A system comprising:
a porous carbon production system configured to produce pyrolyzed, activated carbon particles;
a multi-stage classification system configured to separate the pyrolyzed, activated carbon particles into multiple size classes; and
a chemical vapor infiltration system configured separately infiltrate pores of at least one of the size classes of the pyrolyzed, activated carbon particles with an electrochemical modifier to form uniformly sized composite particles.

9. The system of claim 8, further comprising a blending device configured to blend the uniformly sized composite particles from two or more of the size classes based on a predefined specification.

10. The system of claim 8, wherein the multi-stage classification system comprises a plurality of elbow jet classifiers.

11. The system of claim 10, wherein the plurality of elbow jet classifiers comprises:
a first elbow jet classifier configured to separate the pyrolyzed carbon particles into a first target size range and one or more non-target size ranges;
a second elbow jet classifier configured to:
receive the pyrolyzed carbon particles associated with a first one of the non-target size ranges from the first elbow jet classifier; and
separate the pyrolyzed carbon particles into a second target size range and one or more non-target size ranges; and
a third elbow jet classifier configured to:
receive the pyrolyzed carbon particles associated with a second one of the non-target size ranges from the first elbow jet classifier; and
separate the pyrolyzed carbon particles into a third target size range and one or more non-target size ranges.

12. The system of claim 11, wherein:
the second elbow jet classifier is further configured to send the pyrolyzed carbon particles associated with a third one of the non-target size ranges to the first elbow jet classifier for reprocessing; and
the third elbow jet classifier is further configured to send the pyrolyzed carbon particles associated with a fourth one of the non-target size ranges to the first elbow jet classifier for reprocessing.

13. The system of claim 11, wherein one or more of the elbow jet classifiers comprises a reflux device configured to reprocess a portion of the pyrolyzed carbon particles associated with any of the target size ranges.

14. The system of claim 10, further comprising one or more hoppers configured to receive pyrolyzed carbon particles to be fed to one or more of the elbow jet classifiers.

15. The system of claim 14, wherein the one or more hoppers comprise one or more cyclone hoppers.

16. A particle classification system comprising:
a plurality of elbow jet classifiers configured to separate pyrolyzed, activated carbon particles into multiple size classes.

17. The system of claim 16, wherein the plurality of elbow jet classifiers comprises:
a first elbow jet classifier configured to separate the pyrolyzed carbon particles into a first target size range and one or more non-target size ranges;
a second elbow jet classifier configured to:
receive the pyrolyzed carbon particles associated with a first one of the non-target size ranges from the first elbow jet classifier; and
separate the pyrolyzed carbon particles into a second target size range and one or more non-target size ranges; and
a third elbow jet classifier configured to:
receive the pyrolyzed carbon particles associated with a second one of the non-target size ranges from the first elbow jet classifier; and
separate the pyrolyzed carbon particles into a third target size range and one or more non-target size ranges.

18. The system of claim 17, wherein:
the second elbow jet classifier is further configured to send the pyrolyzed carbon particles associated with a third one of the non-target size ranges to the first elbow jet classifier for reprocessing; and
the third elbow jet classifier is further configured to send the pyrolyzed carbon particles associated with a fourth one of the non-target size ranges to the first elbow jet classifier for reprocessing.

19. The system of claim 17, wherein one or more of the elbow jet classifiers comprises a reflux device configured to reprocess a portion of the pyrolyzed carbon particles associated with the target size range.

20. The system of claim 16, further comprising one or more hoppers configured to receive pyrolyzed carbon particles to be fed to one or more of the elbow jet classifiers.
